(19) United States
(12) Patent Application Publication
(10) Pub. No.: US 2018/0067209 A1
(43) Pub. Date: Mar. 8, 2018

(54) METHOD AND APPARATUS FOR PROCESSING SPECTRAL IMAGES

(71) Applicant: BAE Systems PLC, London (GB)

(72) Inventors: Gary John Bishop, South Gloucestershire (GB); Adrian Simon BLAGG, South Gloucestershire (GB)

(21) Appl. No.: 15/554,024

(22) PCT Filed: Mar. 1, 2016
(86) PCT No.: PCT/GB2016/050527

§ 371 Date: Aug. 28, 2017

(30) Foreign Application Priority Data
Mar. 6, 2015 (GB) 1503912.6

(51) Int. Cl. G01S 17/02; G01C 13/00; G01S 17/89

(52) U.S. Cl. CPC G01S 17/023; G01N 2021/1793; G01S 17/89; G01C 13/008

(57) ABSTRACT

A method of processing a remotely sensed multispectral or hyperspectral image captured in respect of an area of interest including a body of water so as to identify a submerged target, the method comprising obtaining (206), from hydrographic LiDAR measurements, data representative of water depth in respect of said body of water in said area of interest, performing (210) geo-rectification in respect of said hyperspectral image and said water depth data, applying a hydrologic radiative analysis process (211) to said multispectral or hyperspectral image so as to calculate, using said water depth data obtained from said hydrographic LiDAR measurements, data representative of (i) scattered solar radiation and (ii) spectral transmission between a surface of said body of water and a submerged target and subtracting (212) data representative of said scattered solar radiation from said multispectral or hyper spectral image and multiplying a resultant image by data representative of said spectral transmission so as to recover a spectral signature representative of said submerged target.

This invention relates generally to a method and apparatus for processing spectral images and, more particularly but not necessarily exclusively, to a method and apparatus for processing remotely sensed spectral images for the purpose of identifying submerged objects within a body of water.

Remote sensing techniques are known for monitoring the sea, and other large bodies of water, and thus detecting underwater targets, hazards and activity. Such techniques tend to employ airborne spectrographic imaging systems, for collecting multispectral or hyperspectral images representative of radiation from an area of interest. In general, it is the image data collected at the visible wavelengths that are employed to analyse a body of water in this regard.

It would be desirable to be able to use hyper or multispectral sensing to uniquely identify an object, such as a submerged target, through its spectral signature by the use of a technique known as spectral match filtering. This normally involves comparing a measured signature with values in a database. If an object is viewed at a distance, then atmosphere will affect the signature of the target and atmospheric correction techniques are known for use in removing the effects of the atmosphere and enabling comparisons between the measured signature and those contained in the database.

However, the signatures of objects viewed through water are significantly altered thereby, and even a few centimetres of water can significantly change (through loss, for example) a target's spectral signature. Standard atmospheric correction techniques are not able to remove the effects of water and, therefore, it would be desirable to provide a through-water compensation process in order to retrieve the spectral signature of a submerged object.

In accordance with an aspect of the present invention, there is provided a method of processing a remotely sensed multispectral or hyperspectral image captured in respect of an area of interest including a body of water so as to identify a submerged target, the method comprising:
obtaining, from hydrographic LiDAR measurements, data representative of water depth in respect of said body of water in said area of interest;
performing geo-rectification in respect of said hyperspectral image and said water depth data;
applying a hydrologic radiative analysis process to said multispectral or hyperspectral image so as to calculate, using said water depth data obtained from said hydrographic LiDAR measurements, data representative of (i) scattered solar radiation and (ii) spectral transmission between a surface of said body of water and a submerged target; and
subtracting data representative of said scattered solar radiation from said multispectral or hyperspectral image and multiplying a resultant image by data representative of said spectral transmission so as to recover a spectral signature representative of said submerged target.

The method may further comprise the step of performing atmospheric correction in respect of said remotely sensed multispectral or hyperspectral image.

In an exemplary embodiment of the invention, the method may further comprise the steps of:
performing a detection process in respect of said remotely sensed multispectral or hyperspectral image to identify potential areas of interest comprising locations in said body of water in which submerged objects may be present; and
performing said geo-rectification only in respect of said potential areas of interest.

This has the additional benefit of minimising the computational effort required to perform the geo-rectification process by limiting the process only to areas of the image of potential interest.

The remotely sensed multispectral or hyperspectral image and said hydrographic LiDAR measurements may be collected substantially simultaneously.

In some exemplary embodiments, the hydrologic radiative analysis process may have, as a further input for calculating said data representative of (i) scattered solar radiation and (ii) spectral transmission between a surface of said body of water and a submerged target, data representative of water transmission parameters in respect of said body of water. The data representative of water transmission parameters may include data representative of water clarity, and the data representative of water clarity may be obtained from said hydrographic LiDAR measurements. However, in alternative exemplary embodiments data representative of water clarity may be obtained from stored or previously obtained data in respect of the area of interest.

The method may include the step of using said spectral signature to identify a submerged object of which it is representative.

The step of identifying may comprise inputting data representative of said spectral signature to a matched filter arrangement, said matched filter arrangement including a data base in which is stored data representative of a plurality of spectral signatures representative of respective submerged object types, and identifying a match between said spectral signature and said stored data, thereby to identify said submerged object as a corresponding object type.

In an exemplary embodiment of the invention, the hydrologic radiative analysis process employs a hydrologic radiative transfer model to perform said calculations.

In accordance with another aspect of the present invention, there is provided a multispectral or hyperspectral imaging and analysis apparatus, comprising:
a multispectral or hyperspectral imaging device for capturing a multispectral or hyperspectral image in respect of an area of interest including a body of water;
an input for receiving hydrographic LiDAR measurements in respect of said body of water; and
at least one processor configured to perform the method described above.

Aspects of the present invention may also extend to a program or plurality of programs arranged such that when executed by a computer system or one or more processors, it/they cause the computer system or the one or more processors to operate in accordance with the method described above.

Aspects of the invention extend further to a machine readable storage medium storing a program or at least one of the plurality of programs described above.

Thus, aspects of the present invention provide a through-water compensation technique which uses outputs from a hydrologic radiative analysis process (e.g. a hydrologic radiative transfer model) to calculate factors (i.e. scattered solar radiation and water spectral transmission) required for retrieving a submerged object's source spectral signature. The technique requires knowledge of water depth and clarity and, in accordance with aspects of the present invention, these can be obtained from a simultaneous hydrographic LiDAR measurement.

These and other aspects of the present invention will become apparent from the following specific description, in which embodiments of the present invention are described, by way of examples only, and with reference to the accompanying drawings, in which:

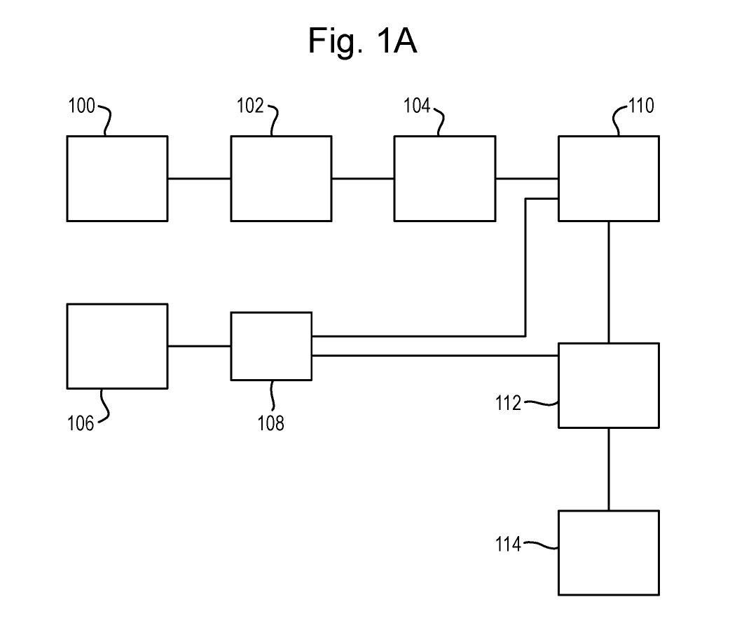

FIG. 1A is a schematic block diagram illustrating a remote sensing apparatus according to an exemplary embodiment of the present invention;

FIG. 1B is a schematic flow diagram illustrating a method according to an exemplary embodiment of the present invention; and

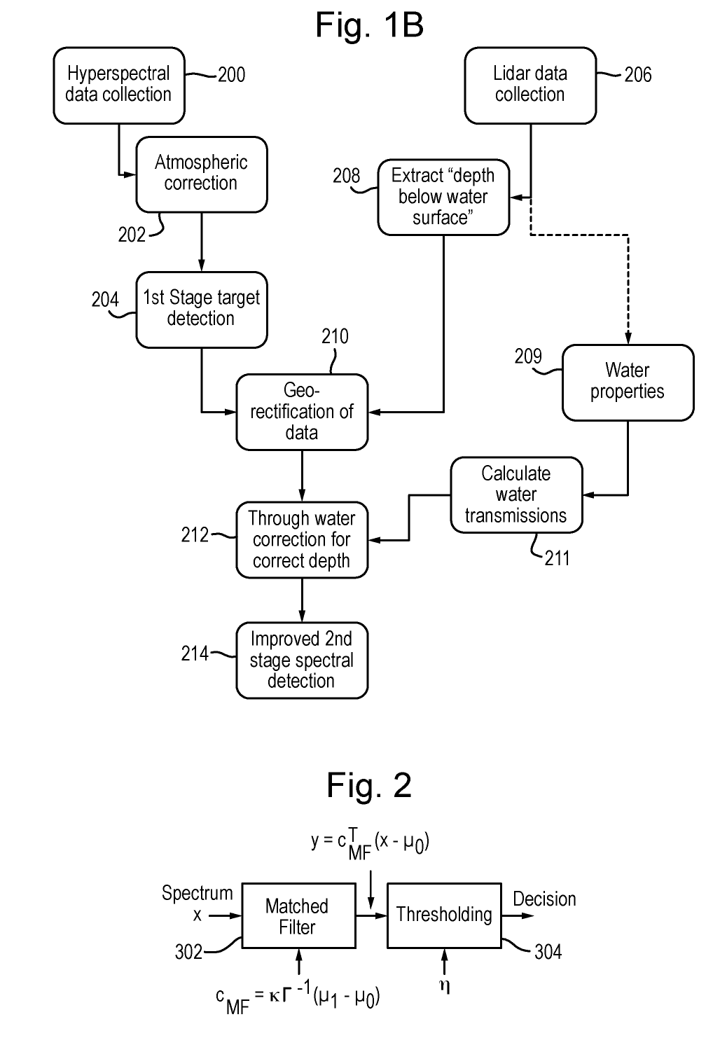

FIG. 2 is a schematic block diagram illustrating the principal of a matched filter detector that may be used in an apparatus according to an exemplary embodiment of the present invention.

Referring to FIG. 1A of the drawings, a remote sensing system according to an exemplary embodiment of the present invention may comprise a hyperspectral imaging system 100 and a bathymetric LiDAR system 106, operating simultaneously in respect of a body of water. The output from the hyperspectral imaging system 100 is fed to an atmospheric correction module 102 and then to a first stage target detection module 104. Simultaneously, the LiDAR data is fed to a water depth and water property calculation module 108. The outputs from the target detection module 104 and the water depth calculation are fed to a geo-rectification module 110 and then to a through water correction module 112, the output of which is fed to a second stage spectral detection module 114 for submerged object detection.

Referring to FIG. 1B of the drawings, in a method according to an exemplary embodiment of the present invention, at step 200, the method starts with the input of captured images from the multispectral or hyperspectral imaging system. For the purposes of the following description, the proposed method will be described in relation to remote sensing of the sea to detect targets, but it will be appreciated that at least some aspects of the invention may be applicable to other applications, and the present invention is not necessarily intended to be limited in this regard. Thus, in this case, the multispectral images provided as the input to the data analysis method may be captured using an airborne spectrographic imaging system such as Compact Airborne Spectrographic Imager (CASI) or the like. However, once again, the present invention is not necessarily intended to be limited in this regard, and a person skilled in the art will be aware of many types of multispectral and hyperspectral imaging systems that could be used as an alternative.

Sequential multispectral and hyperspectral imaging is an acquisition technique that involves collecting images of a target or an area of interest at different wavelengths, to compile a spectrum for each pixel. Multispectral or hyperspectral imaging systems have the ability to provide a continuous graph of the electromagnetic emission from or absorption by a sample of material across a range of the electromagnetic spectrum, and the particular output from the imaging system is dependent on the channels selected by a user, whereby the channels correspond to specified wavelength bands. Thus, for the purposes of this exemplary embodiment of the invention, it is assumed that a single visible-wavelength band (corresponding to any of the wavelengths in the range (380-700 nm) and a single NIR band (corresponding to any of the wavelengths in the range (750-1400 nm) have been selected, such that the input at step 200 of the method illustrated in FIG. 1 of the drawings comprises a set of image frames comprising a single visible image signal and a single NIR image signal, wherein each image frame can be considered to comprise a plurality of pixels which may correspond to an imaged area of, say, 1 m².

When areas are imaged in this manner from a considerable distance, such as is the case with airborne imaging techniques, the intervening atmosphere poses an obstacle to the retrieval of surface reflectance data, and atmospheric correction techniques are therefore typically applied to the spectral data thus collected in order to remove the effects of atmosphere therefrom. Algorithms exist to compensate the measured signal for the effects of the atmosphere, including those that employ statistical models based on empirical in-scene data and physics-based radiative transfer algorithms, and many such atmospheric correction techniques will be known to a person skilled in the art. Thus, purely as an example, a model-based atmospheric correction technique may be applied to the collected spectral data, at step 202, which follows the radiative transfer model shown below:

L₀(λ)=Lₛᵤₙ(λ)T(λ)R(λ)cos(θ)+Lₚₐₜₕ(λ)

where:

(λ)=wavelength

L₀ (λ)=observed radiance at sensor

Lₛᵤₙ(λ)=solar radiance above atmosphere

T(λ)=total atmospheric transmittance

R(λ)=surface reflectance

θ=incidence angle

Lₚₐₜₕ(λ)=path scattered radiance

and as set out in more detail by, for example, Gao B. & Goetz, A. F. H., 1990, Column atmospheric water vapour and vegetation liquid water retrievals for airborne imaging spectrometer data: Journal of Geophysical Research, v. 95, no. D4, p. 3549-3564.

At step 204, first stage target detection may be performed in respect of the atmosphere corrected spectral data, in order to identify likely targets of interest. Once again, any one of a number of known methods may be used for this purpose, including anomaly detection, matched filtering or the masking out of areas known to be of no further interest. Purely by way of example, an optimum matched filter technique is illustrated schematically in FIG. 2 of the drawings, wherein the first part is a linear filter 302 that computes a detection statistic for each pixel, and the second part 304 compares the detection statistic to a predefined threshold to decide whether a target is present or absent.

At the same time as the hyperspectral data collection (step 200) is being performed, LiDAR data collection (step 206) is also being performed. Airborne laser bathymetry (ALB) is a known method for measuring depths of shallow waters from air. Bathymetric LiDAR (Light Detection and Ranging) is used to determine water depth by measuring the time delay between the transmission of a pulse and its return signal. Systems use laser pulses received at two frequencies: a lower frequency infrared pulse is reflected off the water surface, while a higher frequency green laser penetrates through the water column and reflects off the bottom. Analysis of these two distinct pulses can be used to establish water depth, and this is performed at step 208. Of course, it will be appreciated from the above that, by a similar process, the LiDAR data may also be used to identify possible targets of interest for further processing.

Thus, the hyperspectral sensing and LiDAR systems may operate simultaneously from the same aircraft and substantially the same physical location thereon. In order to ensure that pixel-to-pixel matching can be accurately performed in respect of the two sets of data thus separately gathered, it is necessary to perform geo-rectification or geocorrection (at step 210), whereby application of aircraft motion using IMU measurements and application of GPS geographic position data is used to geocode (i.e. assign X and Y coordinates to) the spectral signals received by both the hyperspectral sensing system and the LiDAR system, to give a geocoded “image map”. Techniques for such geo-rectification will be known to a person skilled in the art, and will not be discussed in any further detail herein. It will be appreciated that the geo-rectification step could be performed on the spectral and LiDAR data at the time of collection thereof. However, by performing this step after the first stage target detection step, in respect only of the areas of potential further interest, much less computational effort is likely to be required, which may greatly increase the speed of operation of the system.

As stated above, water can remove a significant amount of the spectral information from the spectral data collected at step 200. Thus, the system is unable to uniquely identify objects therefrom using conventional techniques such as spectral match filtering and, at the first stage target detection step (204) referenced above, the system can only classify an area as anomalous to the immediate background, and cannot use the data to identify particular targets. Standard atmospheric correction techniques are not able to remove the effects of water and, therefore, a through-water compensation process is proposed herein to retrieve the spectral signature of a submerged object.

In accordance with an exemplary embodiment of the present invention, it is proposed to employ a hydrologic radiative transfer model, such as Hydrolight, to facilitate the through-water compensation indicated at step 212. Hydrolight, as will be well known to a person skilled in the art, has as its inputs the water absorption and scattering properties, the sky conditions and the bottom boundary conditions in respect of a body of water. It then solves the scalar radiative transfer equation (RTE) to compute the in-water radiance as a function of depth, direction and wavelength. Hydrolight and other hydrologic radiative analysis processes can be used, therefore, to calculate scattered sunlight between the water surface and a submerged object and spectral transmission through the water between the surface and the submerged object.

In order that the estimated signal(s) modelled by Hydrolight is/are sufficiently accurate, knowledge of the water depth and clarity at each precise location is required. Such data may be derived, in prior art systems, as a user input or based on properties generic to the observed region. However, in accordance with this aspect of the present invention, the water depth for each pixel point can be accurately determined and obtained from the corresponding LiDAR data.

Thus, on a pixel-by-pixel basis, at least the water depth is fed into the Hydrolight (or similar) system in order to calculate the above-mentioned factors. Once these factors have been calculated, they can be used, at step 212, for the through-water compensation process. This occurs in two stages:
(1) remove, from the spectral image, the contribution from the scattered sunlight; and
(2) multiply the spectral image by the water spectral transmission.

As a result, a spectral signal is recovered that represents the true reflectivity of the target (as if it were located at the water surface)>

At step 214, this spectral signature may then be subjected to spectral match filtering in order to uniquely identify the submerged object or target to which it relates.

As stated above, Hydrolight has, as one of its inputs, water depth, and this is derived from and provided by the LiDAR data collected simultaneously with the spectral data, in accordance with the above-described exemplary embodiment of the present invention. The water properties, i.e. water absorption and scattering properties, are employed by Hydrolight to calculate the transmission properties of the water column. This is done based upon the known physical/optical properties of the water column and accounts for the clarity of the water as well as the contribution from suspended matter such as algae and particulate materials. The known depth and optical properties of the water column allow the spectra of any submerged objects to have the contributions from water transmission removed, hence recovering the material reflectance spectra and, as atmospheric correction has already been performed (at step 202), only the water transmission remains to be removed for a full correction to be achievable at step 212.

The above-mentioned water properties may be generic for the observed region, and Hydrolight may employ generic/seasonal/local measurement of the water properties to provide fairly accurate properties. However, to further enhance performance and accuracy of the target identification method, such water properties may alternatively be extracted from the collected LiDAR data. Water clarity (i.e. how far down light penetrates through water) is directly linked to, and can be estimated with reference to, the diffuse attenuation coefficient of downwelling irradiance K_{d}. In simple terms, K_{d} is directly related to the total (water+particulates) scattering and absorption coefficient, and inversely related to the zenith angle of refracted solar photons (direct beam) just beneath the water surface. Attenuation of the LiDAR volume back-scattering with depth is linked to K_{d}. Thus, bathymetric LiDAR can be used (at step 209) to determine, not only water depth, but also a good estimate of water clarity.

Irrespective of how the water properties are obtained and provided to the Hydrolight system, the use of the fully corrected spectral data recovered from the collected signal in the second stage spectral detection module provides significantly improved results relative to prior art systems, which use (at least partially) uncorrected data, due to the removal of water effects from the data. The improvement in anomaly detection also beneficial. The full correction described above, performed with accurately known water depth measurements (from the LiDAR data) significantly increases the results of any matched filtering algorithm, which would otherwise be severely limited due to data lost as a result of water absorption.

It will be understood that, for the complete compensation process (water and atmosphere) to work optimally, a calibration of the modules used should be performed against standard targets of known reflectance so that the instrument-measured signal can be converted to reflectivity. This is typically carried out in a laboratory or the like, but the present invention is in no way intended to be limited in this regard.

It will be appreciated by a person skilled in the art, from the foregoing description, that modifications and variations can be made to the described embodiments without departing from the scope of the invention as claimed.

What is claimed is:

1. A method of processing a remotely sensed multispectral or hyperspectral image captured in respect of an area of interest including a body of water so as to identify a submerged target, the method comprising:
obtaining, from hydrographic LiDAR measurements, data representative of water depth in respect of said body of water in said area of interest;
performing geo-rectification in respect of said hyperspectral image and said water depth data;
applying a hydrologic radiative analysis process to said multispectral or hyperspectral image so as to calculate, using said water depth data obtained from said hydrographic LiDAR measurements, data representative of (i) scattered solar radiation and (ii) spectral transmission between a surface of said body of water and a submerged target; and
subtracting data representative of said scattered solar radiation from said multispectral or hyperspectral image and multiplying a resultant image by data representative of said spectral transmission so as to recover a spectral signature representative of said submerged target.

2. The method according to claim 1, further comprising the step of performing atmospheric correction in respect of said remotely sensed multispectral or hyperspectral image.

3. The method according to claim 1, comprising the steps of:
performing a detection process in respect of said remotely sensed multispectral or hyperspectral image to identify potential areas of interest comprising locations in said body of water in which submerged objects may be present; and
performing said geo-rectification only in respect of said potential areas of interest.

4. The method according to claim 1, wherein said remotely sensed multispectral or hyperspectral image and said hydrographic LiDAR measurements are collected substantially simultaneously.

5. The method according to claim 1, wherein said hydrologic radiative transfer model has, as a further input, data representative of water transmission parameters in respect of said body of water obtained from said hydrographic LiDAR measurements.

6. The method according to claim 5, wherein said data representative of water transmission parameters includes data representative of water clarity.

7. The method according to claim 1, including the step of using said spectral signature to identify a submerged object of which it is representative.

8. The method according to claim 7, wherein said step of identifying comprises inputting data representative of said spectral signature to a matched filter arrangement, said matched filter arrangement including a data base in which is stored data representative of a plurality of spectral signatures representative of respective submerged object types, and identifying a match between said spectral signature and said stored data, thereby to identify said submerged object as a corresponding object type.

9. A multispectral or hyperspectral imaging and analysis apparatus suitable for processing a remotely sensed multispectral or hyperspectral image captured in respect of an area of interest including a body of water so as to identify a submerged target, the method comprising, the apparatus comprising:
a multispectral or hyperspectral imaging device for capturing a multispectral or hyperspectral image in respect of an area of interest including a body of water;
an input for receiving hydrographic LiDAR measurements in respect of said body of water; and
at least one processor configured to:
obtain, from hydrographic LiDAR measurements received via the input, data representative of water depth in respect of said body of water in said area of interest;
perform geo-rectification in respect of said hyperspectral image and said water depth data;
apply a hydrologic radiative analysis process to said multispectral or hyperspectral image so as to calculate, using said water depth data obtained from said hydrographic LiDAR measurements, data representative of (i) scattered solar radiation and (ii) spectral transmission between a surface of said body of water and a submerged target; and
subtract data representative of said scattered solar radiation from said multispectral or hyperspectral image and multiplying a resultant image by data representative of said spectral transmission so as to recover a spectral signature representative of said submerged target.

10. Non-transient media containing software configured to direct a computer system or one or more processors to to:
receive, from hydrographic LiDAR measurements, data representative of water depth in respect of said body of water in said area of interest;
perform geo-rectification in respect of said hyperspectral image and said water depth data;
apply a hydrologic radiative analysis process to said multispectral or hyperspectral image so as to calculate, using said water depth data obtained from said hydrographic LiDAR measurements, data representative of (i) scattered solar radiation and (ii) spectral transmission between a surface of said body of water and a submerged target; and
subtract data representative of said scattered solar radiation from said multispectral or hyperspectral image and multiplying a resultant image by data representative of said spectral transmission so as to recover a spectral signature representative of said submerged target.

11. (canceled)
